(19) United States
(12) Patent Application Publication
(10) Pub. No.: US 2012/0005675 A1
(43) Pub. Date: Jan. 5, 2012

(54) APPLYING PEER-TO-PEER NETWORKING PROTOCOLS TO VIRTUAL MACHINE (VM) IMAGE MANAGEMENT

(75) Inventor: Abraham Benjamin de Waal, San Jose, CA (US)

(73) Assignee: BruteSoft, Inc., Los Altos, CA (US)

(21) Appl. No.: 13/012,785

(22) Filed: Jan. 24, 2011

Related U.S. Application Data
(60) Provisional application No. 61/297,520, filed on Jan. 22, 2010.

(51) Int. Cl. G06F 9/455

(52) U.S. Cl. 718/1

(57) ABSTRACT

A method to establish a peer-to-peer network connection between two physical machines for distributing virtual machine images between the machines based on users' end user roles is provided. A first physical machine receives, from a second physical machine, a first virtual machine image corresponding to a first end user role and subsequently the first physical machine receives a second virtual machine image corresponding to a second end-user role from the second physical machine. Another method provides for partitioning a virtual machine image file into a plurality of blocks, each identified with a corresponding hash code where the corresponding hash/block pairs are stored in a distributed hash table. A list of the hash codes is sent to a target machine and the unique hash codes are maintained until the complete virtual machine image file is received by the target machine.

This application claims the priority benefit of U.S. Provisional Application No. 61/297,520, filed Jan. 22, 2010 and titled “APPLYING PEER-TO-PEER NETWORKING PROTOCOLS TO VIRTUAL MACHINE (VM) IMAGE MANAGEMENT,” which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011, BRUTESOFT, INC. All Rights Reserved.

### TECHNICAL FIELD

The present application relates generally to the technical field of data processing and more particularly to computer processing and digital data processing systems.

### BACKGROUND

The costs of operating large data centers are tremendous. Power consumption makes up a big part of this, since it affects the amount of electricity used, the amount of cooling needed, the maximum density of computation units, etc. If one may reduce power while keeping performance constant, we believe it may be a key strategic improvement for the future data center.

Despite various economic downturns, desktops and laptops still comprise the bulk of the devices deployed to empower employees in enterprises, with a predicted worldwide forecast of nearly 290 million desktops and laptops by 2xxx. Provisioning, deploying, and updating these devices still remains a large support function of any enterprise, regardless of size. However, as desktop virtualization becomes more prevalent in these enterprises, the problem relating to downloading these virtual desktop images may only escalate.

Deploying virtual devices, regardless of whether these are virtual desktops or virtual servers, may place additional demands at an increasing pace on a company's Internet technology (IT) group. One of the most time-consuming, mundane, and costly functions of the IT department would be to ensure that these virtual devices are correctly and efficiently enabled when required by the end users. Any solution that allows potential customers to reduce and streamline these activities, and at the same time reduce the cost of delivering these virtual devices, may fulfill a need that may escalate with deployment of virtual devices. A more efficient means of delivery of virtual machine images may allow enterprises to use larger images, a greater variety of images, or permit more terminal/system sharing with a possibly smaller network infrastructure.

Ideally, virtual machine image management would be offered in an enterprise as part of a larger software-as-a-service solution that may enable small and medium companies to access world-class VM management solutions based on a subscription per device. This may allow more efficient and less costly services to these companies that often have limited access to qualified resources to manage their non-core activities.

Delivery of thousands of virtual machine images can potentially become a significant problem for enterprises without central control and management which are attempting to move toward a virtual desktop environment. Another important impact of this solution is the ability to reduce the energy consumption required for repeatedly delivering and running virtual machine images to the end users in the enterprise.

### BRIEF DESCRIPTION OF THE DRAWINGS

Some embodiments are illustrated by way of example and not limitation in the figures of the accompanying drawings in which:

FIG. 1 is a flow diagram of an example embodiment of managing an installation of virtual machine image files according to end-user roles;

FIG. 2 is a flow diagram of an example embodiment of a comparison of measured available bandwidth between a point-to-point network protocol and a peer to peer network protocol;

FIG. 3 is a flow diagram of an example embodiment of partitioning and labeling a virtual machine image file with hash codes for deployment in a network environment; and

FIG. 4 is a block diagram of a machine in the form of an example computer system that may be used for executing instructions that distribute virtual machine images, dynamically throttle peer-to-peer traffic, and migrate modified images.

### DETAILED DESCRIPTION

Example methods and systems to manage and distribute virtual machine images over peer-to-peer networks are described. In the following description, for purposes of explanation, numerous specific details are set forth in order to provide a thorough understanding of example embodiments. It will be evident, however, to one skilled in the art that at least aspects of the inventive subject matter may be practiced without these specific details.

Various example embodiments are discussed herein. For example, various aspects of the inventive subject matter include an application of peer-to-peer (P2P) network protocols to the virtual machine image distribution; dynamic throttling of P2P traffic to reduce bandwidth and power demands; and a mechanism to migrate modified images from one client to another.

This document discusses, with reference to some example embodiments, peer-to-peer network technologies in the virtual machine (VM) image deployment space, and provides some comparisons to traditional point-to-point methods in current use. We want to look not only at applying P2P algorithms to the space, but also discuss their effects on power consumption and on client-to-client transfers. An improvement of efficient VM image deployment is paramount to the success of new desktop initiatives in the developing areas of Virtual Desktop Infrastructure (VDI).

Finding faster ways to deploy large images may change the way virtual machines are managed. For example, if it may be done fast enough, a VM manager may rapidly migrate a VM from one physical machine to another without the need for shared storage to balance machine load, and thus save power and achieve better performance. The VM manager may reuse a VM slot or a physical slice with different images depending on end user roles. For example, a day-shift worker requires one image and a night-shift worker another on the same physical hardware. The VM manager may also allow late binding deployment of images, for example, when the identity of a person logging in is made known, the system can rapidly deploy the appropriate image.

Popular P2P algorithms focus on ‘read-only’ migration of data sets. There is some market advantage for adaptations of the algorithms to handle temporary non-persistent ‘writes’ to the distributed system. This is useful if you simply want to move an image from one place to another.

Underlying P2P systems is a mechanism to distribute file storage over a network of machines. If the machines are relatively near each other, then you can easily saturate your network bandwidth by attempting to obtain all parts of a file at once.

By actively monitoring available network bandwidth, one can throttle the amount of bandwidth used. By applying some level of throttling, combined with the well-established overall speed-up of P2P, one may achieve the same (low) performance as traditional point-to-point protocols, but at reduced power cost. The power savings comes from the shorter distance file blocks has to travel to reach their destination.

Finally, in scenarios where a running virtual machine image is to be migrated to another physical place, one can apply a variation of the algorithm starting with breaking the image into blocks, hashing each block, and adding each hash/block pair to the distributed hashing table (DHT). Next the algorithm proceeds with sending the list of hashes to the target machine. The algorithm concludes with ensuring unique DHT entries are not discarded until the target received its full payload.

For larger images, the likelihood of the entire image to have changed would be low, so the algorithm exploits the caching nature of a DHT and helps the target machine obtain its image faster. If, however, most of the image did change, this worst case may match the point-to-point copy case.

Therefore, applications exist in hardware resource sharing, e.g., using the same VM hardware to support multiple non-concurrent users and in dynamic migration of images for load balancing. Further benefits derived when hardware bandwidth is throttled back are lower power consumption and lower network infrastructure demands.

Example models may take the inputs of Image size in Bytes, Number of clients, and for P2P models; bandwidth throttling (forced utilization as a % of line capacity) and the size of its DHT store (in bytes). For VM image migration, models may take the input of the percentage of data that was modified from the original (as a percentage).

For given inputs, example models may output an estimate of end-to-end migration of the image (e.g., how long it took for the image to be copied from the server to all the clients in seconds), an estimate of the peak power consumed during migration (in Watts), and an estimate of the total energy consumed over the course of the migration (in Joules).

We chose outputs that are material to data center and infrastructure design. Time to completion is a pure performance measurement. Peak power consumed tells us how much infrastructure we need to build for and total energy tells us how big our bills are going to be.

We may instrument each example model to monitor and log its local consumed network bandwidth in fixed time increments. These logs may be analyzed off-line to estimate the peak power and the total energy used.

Peak power would be the log entry with the highest bandwidth entry multiplied by a bandwidth-to-power factor (which is a constant).

Total energy would be the integral of the entire log over the run of the experiment multiplied by the same bandwidth-to-power factor.

A conversion factor between bandwidth (bits/s) and power (W) is a constant for the particular set up that measurements are taken on. If this information is not available (depending on equipment), a one-off experiment to measure power as a function of bandwidth can be performed. Keep in mind that this factor may include the cost of switches in the network path. The SI unit for this factor is Joules/bit.

A comprehensive study of the power and performance space in server-to-client and server-to-server environments is proposed where it is sought to create the six models listed in the table below, take as many measurements as needed over the input space to map out its topology in performance, peak power, and total energy usage, and graph these results. A final step is to make a comparison between the approaches.

Models are developed where fundamentally there may be two code bases, one for traditional server-client models, and one for P2P models. Assumptions are compiled in for the three lesser variations of each.

The P2P models may be built on BruteSoft's existing BruteAPPS product (BruteSoft, Inc., 139 Fremont Avenue, Los Altos, Calif. 94022, United States of America). Instrumentation for measurements may be added. Furthermore, the models may include VM to VM propagation logic.

We may also create an experimentation framework that automates several aspects of the measurement process, such as initialization, running batches of tests, gathering of results, tabulation/storing thereof, clean-up, etc.

In running measurements, the input space to be considered is as follows:

| Input Variable | Min | Max |
|---|---|---|
| Image Size | 4 GB | 16 GB |
| Client Count | 1 | 100 |
| Network Utilization | 5% | 100% |
| Throttle | | |
| DHT Buffer Size | 4 GB | 32 GB |
| Data Modified Size | 0 | 30% |

Image size is chosen to be representative of popular VDI environments e.g., Windows XP®, Vista®, and Windows 7®. Based on known P2P scaling data, linear scaling may be reached before we reach 100 clients.

Depending on available time and success of this step, we may also use heterogeneous clients, in another example. We believe that there may be combinations of thin clients (e.g., storageless terminals with just enough RAM to store and run a single image) and traditional clients (with storage). Thin clients can only participate in the P2P process as pure recipients. We believe it is important to include these machines, since they are cheap and may likely become more predominant in the next few years.

Example Customers:

Enterprises that typically deploy more than 1000 desktops or laptops in distributed locations and that are in the process of switching to a virtualized desktop environment may be the prime customers. In addition, any ISP or service provider that needs to provide multiple virtual images, either to their own datacenter or to their client base, may also have a vested interest in this technology. There are currently more than a half a million companies in the USA alone with more than 1000 desktops or laptops deployed in their organizations. These typically encompass various sectors such as retail, financial, educational, government, manufacturing, and health in the Small and Medium Business environments.

We proposed offering the virtual machine image management in the enterprise as part of a larger software-as-a-service solution that may enable small and medium companies to access world-class VM management solutions based on a subscription per device. This may allow more efficient and less costly services to these companies that often have limited access to qualified resources to manage their non-core activities.

We can expect to see a proliferation of virtualized devices in various configurations as such services takes root in educational institutions and retail organizations, among others. Virtualized devices can solve many problems in certain organizations, but they can also consume a large part of the resources of an IT group if they cannot be effectively and efficiently provisioned each time it is required.

In addition, we expect to see distribution of virtual machine images to increase significantly as enterprises moves more towards virtual solutions. This may drive the need for efficient and effective virtual imaging solutions.

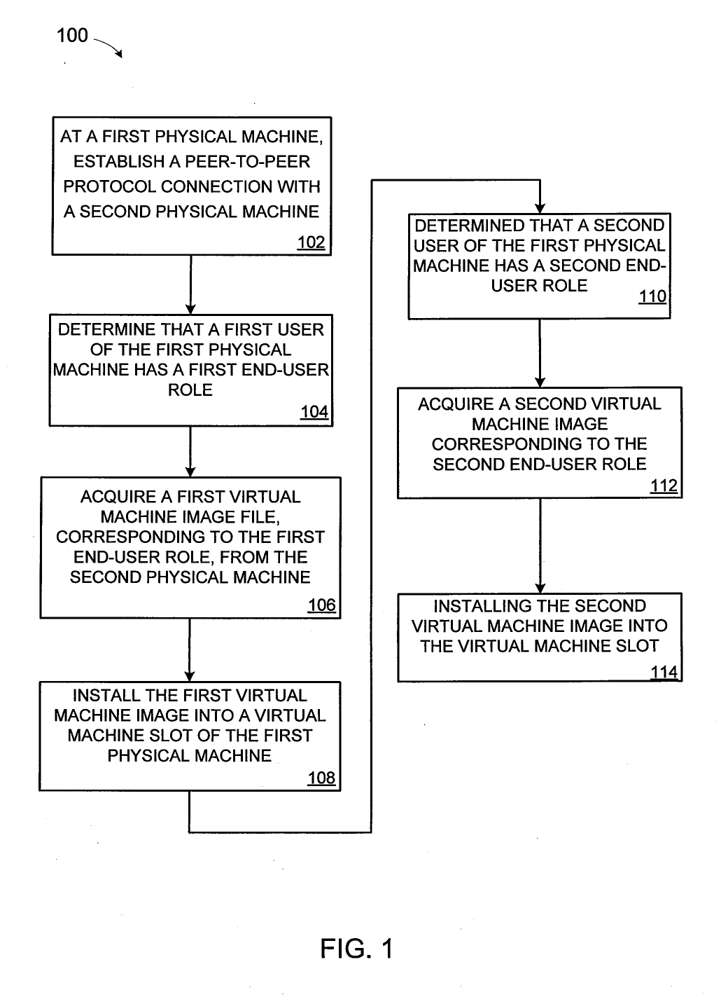

FIG. 1 depicts a process of deploying virtual machine image files 100 corresponding to end-user roles. The process begins at a first physical machine by establishing 102 a peer-to-peer protocol connection with a second physical machine and determining 104 that a first user of the first physical machine has a first end-user role. The process continues with acquiring 106 a first virtual machine image file, corresponding to the first end-user role, from the second physical machine and installing 108 the first virtual machine image into a virtual machine slot of the first physical machine. The process goes on to determine 110 that a second user of the first physical machine has a second end-user role in their after acquiring 112 a second virtual machine image corresponding to the second end-user role. The process concludes with installing 114 the second virtual machine image into the virtual machine slot.

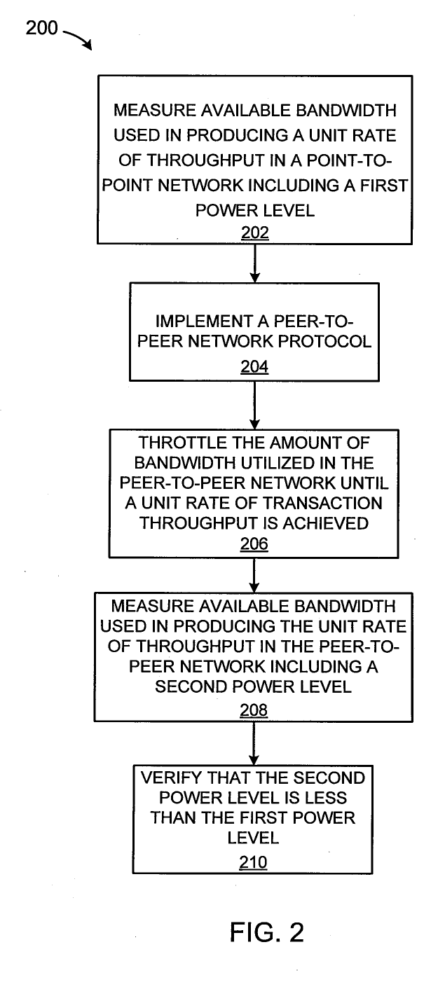

FIG. 2 depicts a process of comparing 200 power levels between a point-to-point network protocol and a peer-to-peer network protocol. The process commences with measuring 202 and amount of available bandwidth used in processing a unit rate of throughput in a point-to-point network including a first power level and implementing 204 a peer-to-peer network protocol. The process continues with throttling 206 the amount of bandwidth utilized in the peer-to-peer network until a unit rate of transaction throughput is achieved and measuring 208 available bandwidth used in producing the unit rate of throughput in the peer-to-peer networking including a second power level. The process concludes with verifying 210 that the second power level is less than the first power level.

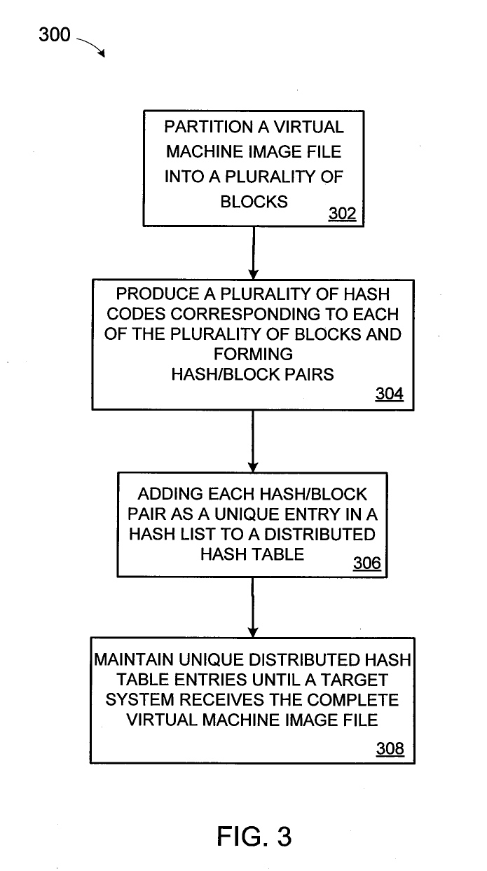

FIG. 3 depicts a process of partitioning a virtual machine image file 304 deployment in a network environment. The process commences with partitioning 302 a virtual machine image file into a plurality of blocks and producing 304 a plurality of hash codes corresponding to each of the plurality of blocks forming hash/block pairs. The process continues with adding 306 each hash/lock pair as a unique entry in a hash list to a distributed hash table and maintaining 308 unique distributed hash table entries until a target system receives the complete virtual machine image file.

### Modules, Components and Logic

Certain embodiments are described herein as including logic or a number of components, modules, or mechanisms. Modules may constitute either software modules (e.g., code embodied on a non-transitory machine-readable medium) or hardware modules. A hardware module is tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a non-transitory machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a clientserver relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

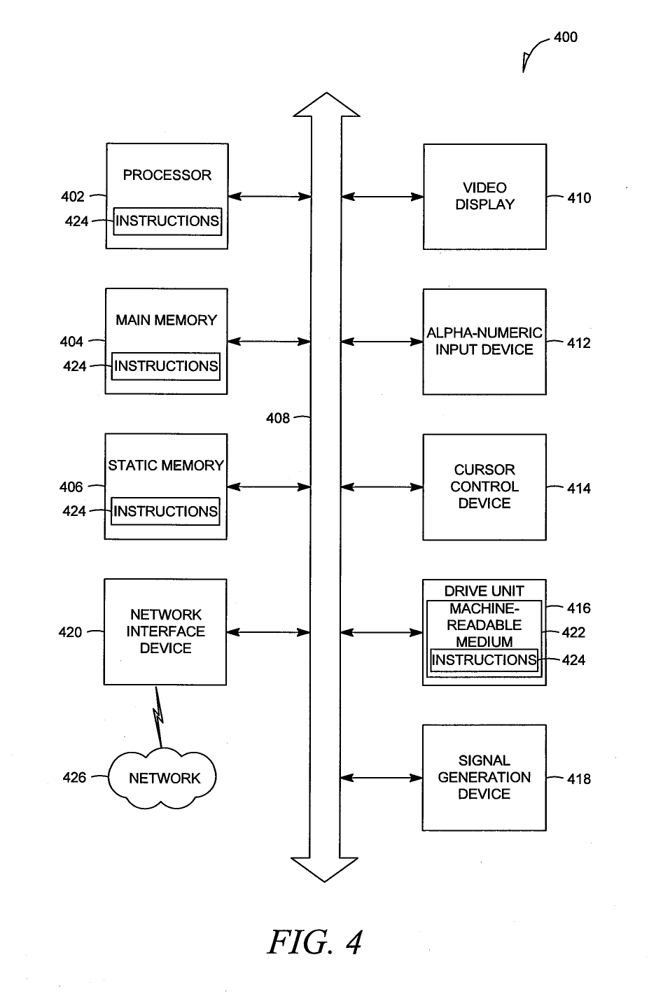

FIG. 4 is a block diagram of a machine in the example form of a computer system 400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

### Machine-Readable Medium

The disk drive unit 416 includes a non-transitory machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting non-transitory machine-readable media.

While the non-transitory machine-readable medium 422 is shown in an example embodiment to be a single medium, the term “non-transitory machine-readable medium” may include a single medium or multiple media (e.g., a centralized or distributed database, and/or associated caches and servers) that store the one or more instructions or data structures. The term “non-transitory machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include nonvolatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Thus, a method and system to applying cloud computing as a service for enterprise software and data provisioning have been described. Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
at a first physical machine, establishing a peer-to-peer network protocol connection with a second physical machine within a network environment;
determining that a first user of the first physical machine has a corresponding first end-user role;
acquiring a first virtual machine image file from the second machine, the first virtual machine image file corresponding to the first end-user role, the image file acquisition accomplished without using shared storage to balance a machine load between the first physical machine and the second physical machine; and
installing the first virtual machine image into a virtual machine slot of the first physical machine.

2. The method of claim 1, further comprising:
determining that a second user of the first physical machine has a corresponding second end-user role;
acquiring a second virtual machine image corresponding to the second end-user role; and
installing the second virtual machine image into the virtual machine slot.

3. A non-transitory machine-readable storage medium containing instructions that, when executed by one or more processors, implement a method comprising:
at a first physical machine, establishing a peer-to-peer network protocol connection with a second physical machine within a network environment;
determining that a first user of the first physical machine has a corresponding first end-user role;
acquiring a first virtual machine image file from the second machine, the first virtual machine image file corresponding to the first end-user role, the image file acquisition accomplished without using shared storage to balance a machine load between the first physical machine and the second physical machine; and
installing the first virtual machine image into a virtual machine slot of the first physical machine.

4. The non-transitory machine-readable storage medium of claim 3, further comprising:
determining that a second user of the first physical machine has a corresponding second end-user role;
acquiring a second virtual machine image corresponding to the second end-user role; and
installing the second virtual machine image into the virtual machine slot.

5. A method comprising:
measuring a portion of available network bandwidth used in producing a unit rate of transaction throughput in an implementation of a point-to-point network protocol, the measuring including a first power level associated with the point-to-point network protocol during production of the unit of transaction throughput;
implementing a peer-to-peer network protocol;
throttling the amount of bandwidth utilized in the peer-to-peer network protocol at least until a unit rate of transaction throughput equal to the implementation of the point-to-point network protocol is achieved;
measuring a portion of available network bandwidth used in producing the unit of transaction throughput in an implementation of the peer-to-peer network protocol, the measuring including a second power level associated with the peer-to-peer network protocol during production of the unit of transaction throughput; and
verifying that the second power level is less than the first power level.

6. The method of claim 5, further comprising injecting a virtual machine image into a first node of a network implementing the peer-to-peer network protocol.

7. A non-transitory machine-readable storage medium containing instructions that, when executed by one or more processors, implement a method comprising:
measuring a portion of available network bandwidth used in producing a unit rate of transaction throughput in an implementation of a point-to-point network protocol, the measuring including a first power level associated with the point-to-point network protocol during production of the unit of transaction throughput;
implementing a peer-to-peer network protocol;
throttling the amount of bandwidth utilized in the peer-to-peer network protocol at least until a unit rate of transaction throughput equal to the implementation of the point-to-point network protocol is achieved;
measuring a portion of available network bandwidth used in producing the unit of transaction throughput in an implementation of the peer-to-peer network protocol, the measuring including a second power level associated with the peer-to-peer network protocol during production of the unit of transaction throughput; and
verifying that the second power level is less than the first power level.

8. The non-transitory machine-readable storage medium of claim 7, further comprising injecting a virtual machine image into a first node of a network implementing the peer-to-peer network protocol.

9. A system comprising:
a hardware means for monitoring available network bandwidth used in producing a unit of transaction throughput in an implementation of a point-to-point network protocol;
means for implementing a peer-to-peer network protocol; and
means for throttling the amount of bandwidth utilized in the peer-to-peer network protocol until a transaction throughput equal to the implementation of the point-to-point network protocol is achieved.

10. A method comprising:
partitioning a virtual machine image file into a plurality of blocks, the virtual machine image file being destined for a target system;
producing a plurality of hash codes corresponding to each respective one of the plurality of blocks, an alignment of one of the plurality of hash codes with a respective one of the plurality of blocks forming a hash/block pair;
adding each hash/block pair as a unique entry in a hash list to a distributed hash table;
sending the hash list to the target system; and
maintaining the unique distributed hash table entries corresponding to the hash list at least until the target system has received the complete virtual machine image file.

11. The method of claim 10, further comprising caching the added hash/block pairs within the distributed hash table and across at least one of enterprise storage and cloud storage.

12. A non-transitory machine-readable storage medium containing instructions that, when executed by one or more processors, implement a method comprising:
partitioning a virtual machine image file into a plurality of blocks, the virtual machine image file being destined for a target system;
producing a plurality of hash codes corresponding to each respective one of the plurality of blocks, an alignment of one of the plurality of hash codes with a respective one of the plurality of blocks forming a hash/block pair;
adding each hash/block pair as a unique entry in a hash list to a distributed hash table;
sending the hash list to the target system; and
maintaining the unique distributed hash table entries corresponding to the hash list at least until the target system has received the complete virtual machine image file.

13. The non-transitory machine-readable storage medium of claim 12, further comprising caching the added hash/block pairs within the distributed hash table and across at least one of enterprise storage and cloud storage.
